(19) United States
(12) Patent Application Publication
(10) Pub. No.: US 2020/0130641 A1
(43) Pub. Date: Apr. 30, 2020

(54) SEAT BELT RETRACTOR

(71) Applicant: AUTOLIV DEVELOPMENT AB, VARGARDA (SE)

(72) Inventor: RONALD JABUSCH, ELMSHORN (US)

(73) Assignee: AUTOLIV DEVELOPMENT AB, VARGARDA (SE)

(21) Appl. No.: 16/196,127

(22) Filed: Nov. 20, 2018

(30) Foreign Application Priority Data
Oct. 25, 2018 (DE) 10 2018 218 293.0

(51) Int. Cl. B60R 22/34; B60R 22/46

(52) U.S. Cl. CPC B60R 22/3413; B60R 22/46

(57) ABSTRACT

A seat belt retractor (40) having a belt spool (14), a seat belt (12) that can be wound thereon to a belt spool, and at least a first and a second assembly (1, 2), wherein the first and the second assembly (1, 2) are arranged coaxially to each other and at a first angle (A) to the rotational axis (B) of the belt spool (14) and are connected together by a flex coupling or an angular gear.

### CROSS-REFERENCE TO RELATED APPLICATION

This application claims the benefit of priority under 35 U.S.C. § 119 to German Patent Application No. 10 2018 218 293.0, filed Oct. 25, 2018, the contents of which are incorporated herein by reference in their entirety.

### FIELD OF THE INVENTION

The present invention relates to a seat belt retractor for a motor vehicle.

### BACKGROUND

Seat belt retractors have as basic components a load-bearing frame and a belt spool that is rotatably mounted in the frame and on which the seat belt can be wound. The frame also serves, in addition to bearing the belt spool, to be mounted on a seat structure or a vehicle structure and is manufactured for this purpose from a correspondingly thick steel sheet, which is bent into a U-shaped frame.

Vehicle seats with seat belt restraint devices are known to be used, for example, as front seats in convertibles in which at least the seat belt retractor of the seat belt mechanisms are mounted in the backrest of the vehicle seats. Due to the lack of a load-bearing B column and due to reasons of access to the rear seats or due to the distance to the rear vehicle structure, the seat belt retractors are in this case preferably integrated into the backrests of the vehicle seats, which must thus be designed to absorb the impact forces acting in the case of a belt retention. The seat belt retractors themselves have all the basic components of a standard seat belt retractor and are only provided with various additional assemblies especially for the installation in the backrest, such as, for example, a self-aligning inertia sensor.

The vehicle seat has in its basic design a seat structure consisting of several load-bearing structural parts, which serve for mounting the vehicle seat on the vehicle structure. The seat structure is provided with springs and padding to improve the seating comfort and serves in addition for the mounting of other components, such as, for example, various seat adjustment mechanisms, including the corresponding electric motors and other components, such as heating devices, sensors, displays, headrests, and the like.

In modern vehicles with autonomous driving systems increasingly a greater adjustability of the vehicle seats in different orientations and positions is required, which provides the vehicle passengers with the possibility of a more convenient conversation with other passengers, more extended or intensive rest phases, or also to work due to the freedoms obtained by means of the autonomous driving and to thus be able to correspondingly align the vehicle seat. This has as a consequence that the seat belt mechanism and in particular the seat belt retractor no longer have to be mounted on the vehicle structure as heretofore, but must be mounted on the vehicle seat, as was already the case, for example, with the front seats of convertibles.

However, one problem consists in that the seat belt retractor with its other components has a comparatively large installation space requirement due to its external measurements, so that the installation in the vehicle seat can be problematic. This occurs particularly because the seat belt must have a specific minimum thickness with a predetermined width of, for example, 46 mm, which is required to absorb the impact forces, and a specific minimum length of, for example, 2500 mm, to retain the passengers, so that the belt spool with the belt retractor must have a correspondingly large outer diameter with a fully wound seat belt due to the volume of seat belt to be wound. This large belt retractor is further enlarged toward the outside by a corresponding frame of the seat belt retractor and by at least one first and second assembly, such as, for example, a driving device of an irreversible seat belt tightener (such as a pyrotechnically activated roto pretensioner), an electric motor of a reversible seat belt tightener, a force limiting device, sensing devices, or the like, whereby the installation space requirement is again increased.

Against this background, it is an object of the invention to make available a generic seat belt retractor which can also be arranged within the limited installation space of a vehicle seat.

A seat belt retractor having the features described herein is proposed to attain this object. Other preferred further developments of the invention are disclosed in the dependent claims, the figures, and the corresponding description.

### SUMMARY AND INTRODUCTORY DESCRIPTION OF THE INVENTION

Pursuant to the basic idea of the invention, it is proposed according to arrange the first and second assembly coaxially with respect to each other and at a first angle to the rotational axis of the belt spool.

The geometry of the seat belt retractor can be configured as a result of the proposed solution according to the existing free spaces in the vehicle seat or on the vehicle structure by an angular arrangement of the belt spool with respect to the two assemblies. The seat belt retractor can thereby be configured especially with an angle of less or more than 90 degrees, depending on the available free spaces. The two assemblies are arranged mutually coaxially and in series and form thus together a slender and elongated unit. The constructive disadvantage in the expense for the realization of the angular connection of the belt spools to the assemblies is justifiable by the adaptation of the geometry of the seat belt retractor to the geometry and arrangement of the free spaces available in the vehicle seat.

The first assembly can thereby be an electric motor and the second assembly can be a gear unit that transmits the rotary driving movement of the electric motor to the belt spool, and these form a unit for a reversible seat belt tightening in the coaxial series arrangement. The gear unit transmits a drive torque of approx. 2 Nm to 16 Nm during the reversible belt tightening, which is a comparatively low torque to be transmitted in comparison with the drive torques that are transmitted by other assemblies that will be described in the following, such as, for example, force limiting devices or irreversible tightening devices. Thus the angular arrangement in this interface generates special advantages since here comparatively small torques are to be transmitted within an angle, whereby the constructive effort and the costs connected therewith can be reduced.

It is furthermore proposed to provide a third assembly, which is arranged coaxially and in series to the belt spool or the first and second assembly. The seat belt retractor can be expanded either on the side of the belt spool or on the side of the already existing first and second assembly while retaining its slender elongated geometry.

The third assembly can thereby preferably be a force limiting device, which can be configured, for example, with one stage or also multiple stages.

A fourth assembly which is arranged coaxially and in series with respect to the belt spool or the first and second assembly can also be provided and in turn expands the seat belt retractor by another function while retaining the slender elongated geometry.

The fourth assembly can be, for example, an irreversible belt tightening mechanism.

The slender and elongated geometry of the seat belt retractor is further extended thereby in that also the third and fourth assembly are arranged coaxially and in series with respect to each other.

The belt spool can also preferably be indirectly or directly connected via an angular gear or a flex shaft to the first or second assembly. The angular gear generates a deflection of the rotary motion at an angle that is fixedly determined by the angular gear. The angular gear is designed especially for the angle to be realized and can transmit very large torques with a simultaneously smooth and noiseless operation through the selection of corresponding gear types and materials. The use of the flex shaft has the advantage that also longer distances with simultaneously more complex angular geometries can be bridged. The flex shafts are furthermore comparatively cost effective and can be connected very easily at their ends with the belt spool or with one of the assemblies.

It is furthermore proposed to provide a housing having at least two housing parts, and to arrange the belt spool and the assemblies in different housing parts. The belt spool and the assemblies are thus covered with respect to the outside using housing parts especially adapted thereto. The housing parts can be adapted thereby especially to the outer shape and alignment of the belt spool and the assemblies, wherein they additionally can have a stiffening function in the vehicle seat in that they are integrated into the seat structure.

According to a preferred further development, it is proposed to arrange the two housing parts in which the belt spool and the assemblies are arranged with their longitudinal axes at an angle with respect to each other, which corresponds to the first angle of the arrangement of the first and second assembly with respect to the rotational axis of the belt spool. The housing parts are configured parallel to the longitudinal axes of the coaxial assemblies and parallel to the rotational axis of the belt spool as a result of the proposed configuration. The angle between the belt spool and the assemblies is practically configured between the housing parts.

It is furthermore proposed to arrange the belt spool and the assemblies at a distance with respect to each other and to connect these to each other via the flex shaft, and to provide at least one housing center part between the two housing parts which mutually connects the housing parts that are at an angle with respect to each other. The flex shaft makes possible a transmission of the rotary movement over a long distance in that the flex shaft is selected correspondingly long. The assemblies can thereby be arranged, for example, on one side of a vehicle seat and the belt spool can be arranged on another side of the vehicle seat. The resulting distance between the two housing parts is bridged by the housing center part so that the seat belt retractor has an overall uninterrupted housing.

It is furthermore proposed to arrange further functional components allocated to the assemblies or the belt spool in the housing center part. The distance between the two housing parts is bridged by the housing center part. The housing center part thus does not serve to accommodate another assembly and consequently has a free space which is utilized by the proposed further development to accommodate further functional components of the assemblies or the belt spool. Such functional components can be, for example, a tightening drive tube of an irreversible tightening device, electrical accessories, sensing devices, or the like.

It is furthermore proposed to form the housing parts by means of respective elongated U-profiles. The assemblies and the belt spool can be compactly covered on three sides as a result of the shape of the housing parts, while the fourth open side can be closed by an additional covering part. The housing parts are adapted thereby by the elongated profile shape to the slender design of the seat belt retractor with the coaxially arranged assemblies and the belt spool.

It is furthermore proposed to provide the U-profiles with webs aligned vertical to the longitudinal axes of the U-profiles, which are rotationally connected to the U-profiles with reference to the longitudinal axes of the U-profiles. The hollow space in the U-profiles is divided into various segments by means of the webs. The webs can furthermore serve for a stiffening of the profile rails and additionally to accommodate further functional components. Since the belt spools and the assemblies are aligned parallel to the longitudinal axes of the profile rails with their rotational or longitudinal axes, the webs are additionally arranged vertically to the rotational or longitudinal axis of the belt spool and the assemblies and can in this way serve to accommodate the bearing forces and thus bear the belt spool and the assemblies due to their vertical alignment.

### BRIEF DESCRIPTION OF THE DRAWINGS

The invention will be described below with reference to the included figures with the aid of preferred embodiments, wherein:

FIG. 1 shows a seat belt retractor according to the invention having a flex shaft and an open and closed housing; and

FIGS. 2 to 5 show different views of a seat belt retractor according to the invention having an angular gear; and

FIG. 6 shows the seat belt retractor according to the invention having the flex shaft without housing.

### DETAILED DESCRIPTION

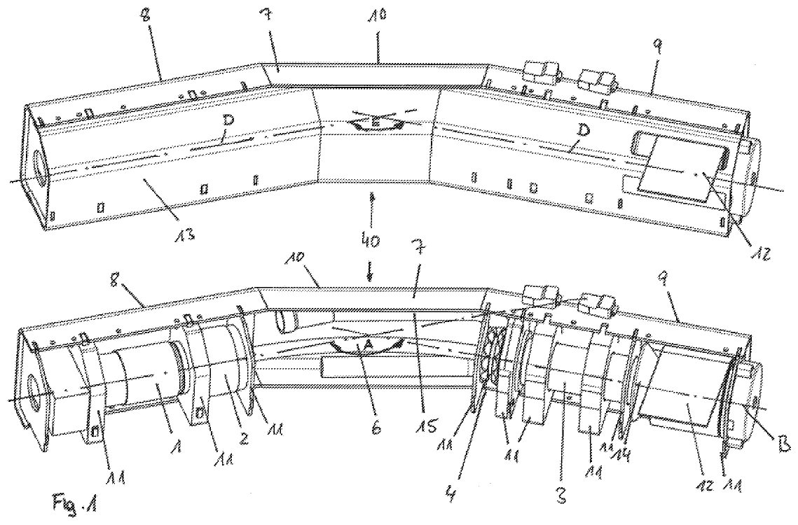

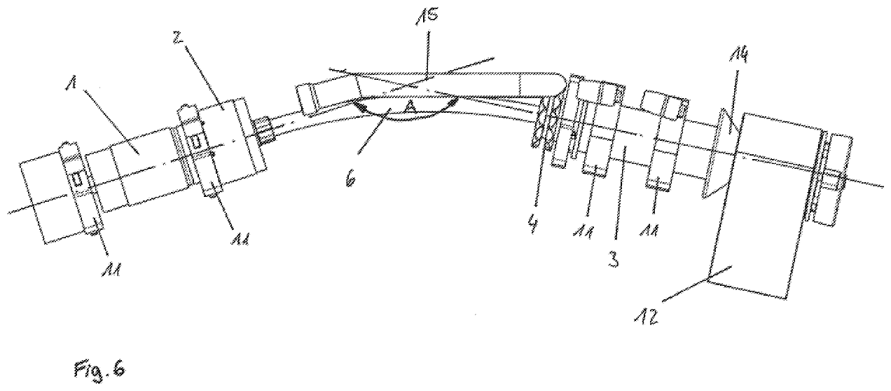

FIGS. 1 and 6 depict a seat belt retractor 40 according to the invention with a safety belt 12 that can be wound on the belt spool 14. The seat belt retractor 40 has a housing 7 consisting of two spaced housing parts 8 and 9 and a housing center part 10 arranged between the housing parts 8 and 9, which is omitted for better viewing in the representation of FIG. 6. The housing parts 8 and 9 as well as the housing center part 10 are configured as elongated U-profiles and are arranged in such a way that the two spaced housing parts 8 and 9 mutually enclose an angle E that is smaller than 180 degrees but greater than 90 degrees with their longitudinal axes D and are connected to each other via the housing center part 10. The open sides of the housing parts 8 and 9 as well as the housing center part 10 are respectively covered via covering parts 13 to form a closed profile, wherein the covering parts 13 were omitted for better visibility in the lower depiction.

Beside the belt spool 14, the seat belt retractor has a first and second assembly 1 and 2 in the form of an electric motor and a gear unit and a third and fourth assembly 3 and 4 in the form of a force limiting device and a pyrotechnic irreversible tightening device, respectively. In the housing parts 8 and 9 are furthermore provided several webs 11 which divide the hollow space in the U-profiles into segments and which are arranged vertically to the longitudinal axes D of the housing parts 8 and 9 and are supported in a form-fitting and rotationally connected manner with reference to the longitudinal axes D on the inner walls of the housing parts 8 and 9. The webs 11 serve to bear the assemblies 1, 2, 3 and 4 and the belt spool 14, as well as to accommodate further functional components of the assemblies 1, 2, 3, 4 and the belt spool, such as, for example, switching mechanisms, sensing devices, electronic components and lines, et cetera.

The first and second assembly 1 and 2 are respectively, an electric motor and a gear unit arranged coaxially and in series to the electric motor, and are aligned with their rotational axes or longitudinal axes at a first angle A to the rotational axis of the belt spool 14. The gear unit is connected or can be connected to the belt spool 14 via an intermediately connected coupling via a flex shaft 6 by the housing center part 10 via the third and fourth assembly 3 and 4. The first and second assembly 1 and 2 are arranged coaxially and in series to each other, so that the seat belt retractor 40 has a slender elongated shape in this region. The belt spool 14 is likewise aligned coaxially and in series to the third and fourth assembly 3 and 4, so that the seat belt retractor 40 also has an elongated slender shape in this section. The housing center part 10 serves for bridging the distance between the housing parts 8 and 9 and connects the housing parts 8 and 9 to the uninterrupted housing 7. The free space in the housing center part 10 is used here again to accommodate a tightening drive tube 15 of the pyrotechnic tightening device. The free space in the housing center part 10 can of course be used beside the tightening drive tube to accommodate further functional components of the different assemblies 1, 2, 3 or 4. The housing center part 10 can be preferably configured more narrow and smaller in its cross sectional surface vertically to the flex shaft 6 than the dimensions of the housing parts 8 and 9 vertically to their longitudinal axes D. The flex shaft 6 is furthermore encased and/or guided by means of a dimensionally stable guiding part. As an alternative or in addition, the flex shaft is also supported at an additional bearing point, which can be realized, for example, by an additional web 11 in the housing center part 10 or in the edge section of the housing parts 8 and 9.

Due to the proposed arrangement of the two assemblies 1 and 2 at the first angle A to the belt spool 14, the seat belt retractor 40 itself is adapted by a corresponding design of the first angle A to an existing free space in a vehicle seat. The use of the flex shaft 6 thereby additionally provides the advantage that the assemblies 1 and 2 can also be arranged at a distance to the belt spool 14, as long as the free spaces available in the vehicle seat are also arranged at a distance with respect to each other. The flex shaft 6 makes possible particularly the arrangement of the assemblies 1 and 2 at different angles A and distances to the belt spool 14 without having to change the design, aside from the housing 7, for this purpose. The seat belt retractor 40 can thereby be better adapted to the geometry of the free space available in the vehicle seat. The housing parts 8 and 9 and the housing center part 10 thus form a slender elongated housing 7 together with the covering parts 13 which cover the assemblies 1, 2, 3 and 4 as well as the belt spool 14 to the outside and protect them from mechanical influences. The housing 7 can however additionally also be used for stiffening the seat structure or other structures of the vehicle and can be correspondingly shaped and designed for this purpose. In the proposed configuration, the seat belt retractor 40 can be arranged, for example, in an upper edge of the seat structure of a backrest, wherein the belt spool 14 is arranged at one end of the seat belt retractor 40, so that the safety belt 12 is guided from a lateral section of the upper edge of the backrest over the shoulder on the upper body of a passenger seated in the vehicle seat in the assembled position of the seat belt retractor 40.

The angle E between the longitudinal axes D of the housing parts 8 and 9 corresponds to the first angle A between the longitudinal or rotational axes of the belt spool 14 and the first and second assembly 1 and 2. The first angle A between the assembly groups 1 and 2 and the belt spool 14 is practically repeated between the housing parts 8 and 9.

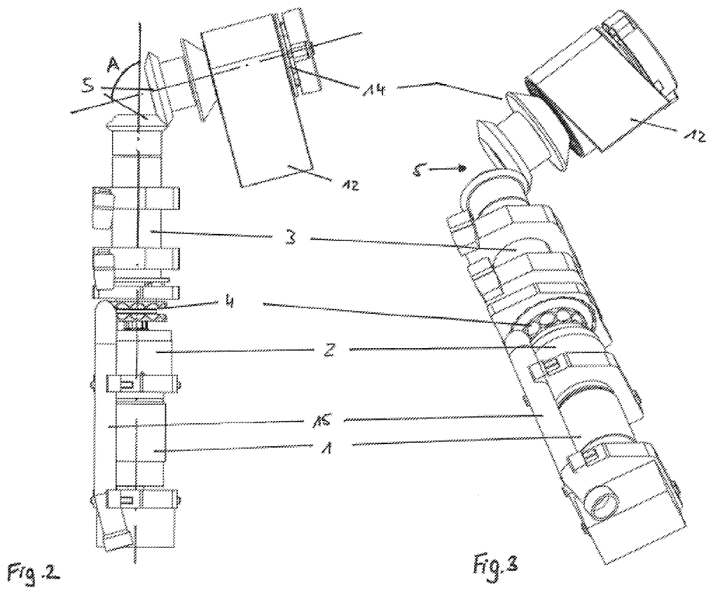

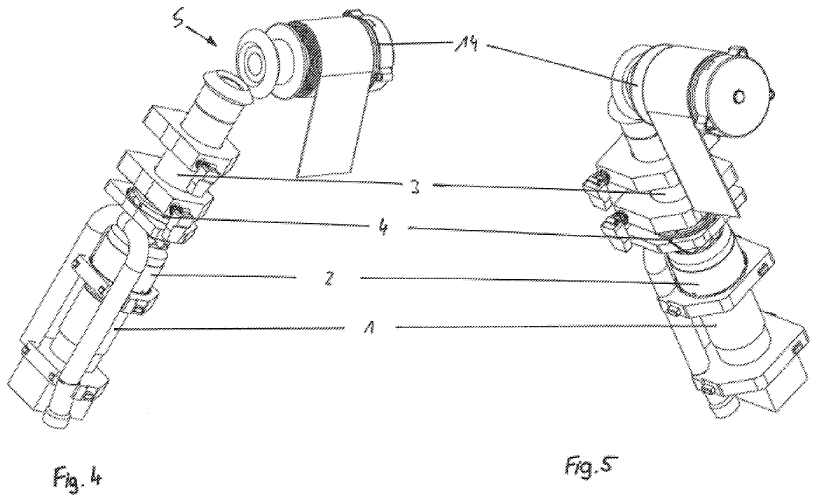

An alternative embodiment of the invention can be seen in FIGS. 2 to 5, in which the assemblies 1, 2, 3 and 4 are arranged coaxially and in series to each other. An angular gear 5 is provided between the third assembly 3, that is, the force limiting device, and the belt spool 14, so that the belt spool 14 can be arranged at a first angle A, for example, greater than 90 degrees, equal to 90 degrees, or less than 90 degrees to the longitudinal axes or rotational axes of the assemblies 1, 2, 3 and 4. The assemblies 1, 2, 3 and 4 thus form a slender, elongated subunit of the seat belt retractor 40, on which the belt spool 14 is arranged laterally at the first angle A. The seat belt retractor 40 can thus preferably be arranged in such a way in the vehicle seat that the assemblies 1, 2, 3 and 4 are arranged in a lateral section in an approximately vertical alignment within the structure of the backrest, and the belt spool 14 is arranged in a lateral section of the upper edge of the backrest. As angular gear 5, for example, one can use a pair of bevel gears, worm gears, crank drive mechanisms, helical gears, et cetera, which are represented herein.

In the exemplary embodiment of FIG. 1, the first and second assemblies, that is, the electric motor with the corresponding gear unit, are oriented at an angle to the belt spool 14 and the third and fourth assembly 3 and 4, so that the rotary movement of the gear unit must be deflected at an angle, which has the advantage that the torque to be deflected at this point is very small, so that the flex shaft 6 is sufficient here.

In the exemplary embodiment of FIGS. 2 to 5, only the belt spool 14 is oriented at an angle to the assemblies 1, 2, 3 and 4 or, otherwise expressed, the assemblies 1, 2, 3 and 4 arranged coaxially and in series to each other are oriented at an angle to the belt spool 14. The torque acting between the belt spool 14 and the force limiting device, which is clearly greater in the retention case, must thus be deflected. The more highly reliable and accurate angular gear 5, in which the rotary movement is transmitted by mutually meshing gearings or other form-fitting connections in a fixed special allocation to each other, is advantageously provided for this purpose.

Since the angular gear for a functionally secure operation presupposes a functionally secure engagement of the gears over a long service life, the angular gear 5 is additionally encapsulated by a separate housing, so that the deflection point is additionally shielded with respect to the interior of the housing 7.

Throughout this description assemblies are described, including the assemblies 1, 2, 3 and 4. These assemblies are provided to influence or control the retraction and extraction of webbing from the belt spool 14. For example, assembly 1 in the form of an electric motor provides rotary motion to rotate spool 14 which can be in the extraction and/or retraction directions. Assembly 2 in the form of a gear unit provides a gear reduction between the output of electric motor 1 and the drive through a flex shaft or other coupling to other assemblies coupled with the belt spool 14. Assembly 3 in the form of a force limiting device is provided to limit tension on belt webbing during a restraint event which is provided for controlling the restraining effect and forces acting on an occupant during an impact. Assembly 4 the form of a pre-tensioner is designed to minimize slack of the belt webbing by forcibly retracting webbing onto belt spool number 14 upon the detection of an impact condition. These assemblies 1, 2, 3 and 4 are connected with one another in a series manner and combine to provide desired control of belt webbing movement through the belt spool 14.

While the above description constitutes the preferred embodiment of the present invention, it will be appreciated that the invention is susceptible to modification, variation and change without departing from the proper scope and fair meaning of the accompanying claims.

1. A seat belt retractor comprising;
a belt spool,
a seat belt that can be wound thereon to a belt spool,
at least a first and a second assembly each for controlling or influencing the winding or extraction of the seat belt on the belt spool, and
the first and the second assembly are arranged coaxially to each other and at a first angle to the rotational axis of the belt spool.

2. The seat belt retractor according to claim 1 further comprising, the first assembly is an electric motor and the second assembly is a gear that transmits a rotary driving movement of the electric motor to the belt spool.

3. The seat belt retractor according to claim 1 further comprising, a third assembly is provided for controlling or influencing the winding or extraction of the seat belt on the belt spool, which is arranged coaxially and in series to the belt spool or the first or the second assembly.

4. The seat belt retractor according to claim 3 further comprising, the third assembly is a force limiting device.

5. The seat belt retractor according to claim 3 further comprising, a fourth assembly is provided for controlling or influencing the winding or extraction of the seat belt on the belt spool, which is arranged coaxially and in series to the belt spool or the first or the second assembly.

6. The seat belt retractor according to claim 5 further comprising, the fourth assembly is an irreversible belt tightening mechanism.

7. The seat belt retractor according to claim 5 further comprising, the third and fourth assembly are arranged coaxially and in series to each other.

8. The seat belt retractor according to claim 1 further comprising, the belt spool is indirectly or directly connected to the first or the second assembly via an angular gear or a flex shaft.

9. The seat belt retractor according to claim 1 further comprising, a housing is provided with at least first and second housing parts, and the belt spool and at least one of the first or second assemblies are arranged in different ones of the first and second housing parts.

10. The seat belt retractor according to claim 9 further comprising, the first and second housing parts, in which the belt spool and the assemblies are arranged, are arranged to each other at an angle of their longitudinal axes, which corresponds to the first angle of the arrangement of the first and second assembly to the rotational axis of the belt spool.

11. The seat belt retractor according to claim 9 further comprising,
the belt spool and the first and second assemblies are arranged at a distance from each other and are mutually connected via a flex shaft, and
at least one housing center part is provided between the first and second housing parts, which mutually connects the first and second housing parts which are positioned at an angle with respect to each other.

12. The seat belt retractor according to claim 11 further comprising, other functional components allocated to the first or the second assemblies or the belt spool are arranged in the housing center part.

13. The seat belt retractor according to claim 9 further comprising, the first and second housing parts are formed by respective elongated U-profiles.

14. The seat belt retractor according to claim 13 further comprising, webs oriented vertically to the longitudinal axes of the U-profiles, which are rotationally connected to the U-profiles with reference to the longitudinal axes of the U-profiles, are provided in the U-profiles.

15. The seat belt retractor according to claim 14, further comprising, at least one of the first or second assemblies or the belt spool are supported in at least one of the webs.

16. The seat belt retractor according to claim 14 further comprising, further functional components of the assemblies or the belt spool are arranged in at least one of the webs.

17. The seatbelt retractor according to claim at 1 further comprising, the first assembly is an electric motor and the second assembly is one of an irreversible belt-tightening mechanism or a force limiting device, and the first and the second assemblies are connected via a flexible shaft.

18. The seatbelt retractor according to claim at 1 further comprising, the first assembly is an electric motor and the second assembly is an irreversible belt-tightening mechanism and a third assembly in the form of a force limiting device, a flexible shaft is positioned between the first and the second assemblies with the force limiting device coupled to the irreversible belt-tightening mechanism.

19. The seatbelt retractor according to claim at 1 further comprising, the first assembly is an electric motor and the second assembly is a gear reduction unit, the first and the second assemblies connected with a third and a fourth assembly by a flexible shaft position between the second and third assemblies.

20. The seatbelt retractor according to claim at 19 further comprising, the third assembly is an irreversible belt-tightening mechanism and the fourth assembly is a force limiting device.
